(19) United States
(12) Patent Application Publication
(10) Pub. No.: US 2023/0211387 A1
(43) Pub. Date: Jul. 6, 2023

(54) DUAL CONTAINED PIPE SCRAPER

(71) Applicant: GLYNWED PIPE SYSTEMS LTD, Kent (GB)

(72) Inventor: Wayne Archer, Staffordshire (GB)

(21) Appl. No.: 18/000,415

(22) PCT Filed: May 28, 2021
(86) PCT No.: PCT/GB2021/051324

§ 371 Date: Dec. 1, 2022

(30) Foreign Application Priority Data
Jun. 2, 2020 (GB) 2008242.6

(51) Int. Cl. B08B 9/02

(52) U.S. Cl. CPC B08B 9/021

(57) ABSTRACT

A pipe scraper (1) comprising: a housing (2) comprising a bore (21) having a centre axis and an open end (24) that allows access to the bore (21), the bore (21) being shaped to receive into its open end (24) at least a portion of each of two pipes (19, 20) of an assembly of two concentric pipes (19, 20), wherein the assembly of two concentric pipes (19, 20) comprises a pipe (19) having a smaller diameter, and a pipe (20) having a larger diameter, and the end of the pipe (20) having the larger diameter is separated from the end of the pipe (19) having the smaller diameter by a distance along the central axis of the assembly; a first scraper tool assembly 9, 10, 11, 16) secured to the housing (2), configured to urge a first scraper tool (9) radially inwards, and positioned at a first radial distance from the centre axis of the bore (21), and at a first axial distance from the open end (24) of the bore (21); a second scraper tool assembly (13, 14, 15, 17) secured to the housing (2), configured to urge a second scraper tool (13) radially inwards, and positioned at a second radial distance from the centre axis of the bore (21), and at a second axial distance from the open end (24) of the bore (21), wherein the first radial distance is smaller than the second radial distance, and the first axial distance is larger than the second axial distance; and a transmission means (4) to allow torque to be delivered to the housing (2) to cause rotation of the housing (2) about the centre axis of the bore (21); wherein the first scraper tool (9) is configured so that rotation of the housing (2) will cause the first scraper tool (9) to scrape portions of a pipe (20) that are in contact with the first scraper tool (9), and wherein the second scraper tool (13) is configured so that rotation of the housing (2) will cause the second scraper tool (13) to scrape portions of a pipe (19) that are in contact with the second scraper tool (13).

### FIELD OF THE INVENTION

This invention relates to devices for preparing pipes for welding by electrofusion.

### BACKGROUND OF THE INVENTION

In piping systems it is desirable to achieve leak free joints, particularly in systems which handle volatile or hazardous fluids, such as fuel delivery systems.

It is common to use polyethylene or polypropylene pipes to transfer fluid in piping systems. Such pipes may be joined using electrofusion welding. Electrofusion welding is a process in which a sleeve is placed over the ends of two pipes which are to be joined, and current is passed through coils embedded in the sleeve. This heats the coils and the adjacent pipe, melting a portion of each pipe, resulting in both pipes being fused to the sleeve.

To ensure that a strong joint is formed, the exterior surfaces of each pipe which will form the joint must be scraped to remove dirt or oxides which could interfere with the electrofusion process and result in low joint strength.

The scraping process is time consuming if done manually using a simple hand scraper, taking several minutes per pipe end to be joined, and the results of such manual scraping can be inconsistent, resulting in weak joints.

Devices are known which assist in scraping pipes. One such device is the scraper of EP 2 368 656 B1. A pipe may be placed within the bore of this device, and the device may be rotated with respect to the pipe. A scraper tool will scrape the outside surface of the pipe as the scraper rotates, and the tool will advance up the pipe as the rotation causes the device to advance along a thread. This device allows for scrapes. The device disclosed in this document also contains a facing tool, which is operable to remove material from the free end of the pipe so that the end surface lies in a single plane.

However, such scrapers are unsuited for use with some piping systems.

In some applications, such as fuel delivery systems, leak prevention and detection is so essential that in addition to the pipes which transfer fluid (primary pipes) further pipes are installed (secondary pipes) which surround the primary pipes, so that any fluid that leaks from a primary pipe is retained within a secondary pipe. This reduces the risk of fluid leaking to the environment, and allows leak detection systems to be installed between the primary and secondary pipes.

Existing devices for scraping pipes are often unsuitable for use with systems of primary and secondary pipes. Often a secondary pipe will interfere with the pipe scraper as the primary pipe is scraped, or vice versa. As a result, it is often necessary to resort to scraping one or both of the pipes manually using a simple hand scraper, which can result in inconsistent scrapes and weak joints. Even if a suitable scraping tool can be found for each pipe, a single scraping tool is unlikely to be compatible with both pipes, so it is necessary to purchase and store two separate tools, and perform two separate scraping operations per pipe end.

It is an object of the invention to provide an improved pipe scraper, and a method for operating an improved pipe scraper.

### SUMMARY OF THE INVENTION

Accordingly, one aspect of the present invention provides a pipe scraper comprising: a housing comprising a bore having a centre axis and an open end that allows access to the bore, the bore being shaped to receive into its open end at least a portion of each of two pipes of an assembly of two concentric pipes, wherein the assembly of two concentric pipes comprises a pipe having a smaller diameter, and a pipe having a larger diameter, and the end of the pipe having the larger diameter is the central axis of the assembly; a first scraper tool assembly secured to the housing, configured to urge a first scraper tool radially inwards, and positioned at a first radial distance from the centre axis of the bore, and at a first axial distance from the open end of the bore; a second scraper tool assembly secured to the housing, configured to urge a second scraper tool radially inwards, and positioned at a second radial distance from the centre axis of the bore, and at a second axial distance from the open end of the bore, wherein the first radial distance is smaller than the second radial distance, and the first axial distance is larger than the second axial distance; and a transmission means to allow torque to be delivered to the housing to cause rotation of the housing about the centre axis of the bore; wherein the first scraper tool is configured so that rotation of the member will cause the first scraper tool to scrape portions of a pipe that are in contact with the first scraper tool, and wherein the second scraper tool is configured so that rotation of the member will cause the second scraper tool to scrape portions of a pipe that are in contact with the second scraper tool.

Preferably, wherein the pipe scraper further comprises a drive cone and an externally threaded rod, wherein the externally threaded rod is coaxial with and positioned within the bore, and is secured to the housing at the end of the bore that is opposite to the open end, wherein the drive cone comprises a conical frustum that is coaxial with and positioned within the bore, the conical frustum itself having a bore that is internally threaded, and that is at least accessible from the broadest end of the conical frustum, and wherein the internal threads of the drive cone are engaged with the external threads of the externally threaded rod such that the narrowest end of the frustum is nearer the open end of the bore than the broadest end.

Even more preferably wherein the drive cone further comprises a cylindrical element integrally formed with or secured to the narrowest end of the frustum, wherein the cylindrical element also comprises a bore which is continuous with the bore of the frustum, and which may receive the externally threaded rod.

Yet more preferably wherein the externally threaded rod further comprises a restraining element that may prevent the advancement of the drive cone towards the open end of the bore to a position in which the drive cone would disengage from the internally threaded rod.

Even more preferably wherein the end of the housing opposite the open end further comprises an anti-binding ball catch having an urging member configured to urge an end of the catch into the bore and away from the end of the housing opposite the open end, the anti-binding ball catch being positioned such that one end of the catch extends into the bore when the urging member is in a resting position.

Advantageously, wherein one of the first and second scraper tool assemblies comprises a lever, an urging member, and the scraper tool, wherein the lever is secured to the housing such that the arms of the lever may pivot radially inwards and outwards with respect to the housing, wherein the scraper tool is attached to a first arm of the lever, and wherein the urging member is arranged to urge the second arm of the lever is radially outwards.

Conveniently, wherein the housing further comprises guide rollers, the guide rollers being components that may freely rotate within cavities in the housing, wherein these cavities are adjacent to and intersect with the bore such that the guide rollers are secured within the cavities and portions of the guide rollers protrude into the bore along the length of the rollers.

Preferably, wherein the bore of the housing comprises a first section having a first internal diameter, and a second section having a second internal diameter, and wherein the first section is located axially closer to the free end of the bore than the second section, and wherein the first internal diameter is larger than the second internal diameter, and wherein the first scraper tool is located in the first section, and the second scraper tool is located in the second section.

A further aspect of the invention provides a method of scraping one end of an assembly of a primary pipe and a secondary pipe, wherein the primary pipe is concentric or substantially concentric with the secondary pipe, and the primary pipe has a smaller radius than that of the secondary pipe, wherein the end of the primary end of the secondary pipe lies in a second plane perpendicular to the central axis of the assembly wherein the first and second planes are separated by a distance and wherein the primary pipe intersects the second plane, and the secondary pipe does not intersect the first plane, such that at least a portion of the primary pipe can be accessed by a tool moving radially inwards from the outside of the primary and secondary pipes, the method including: providing a pipe scraper in accordance with the preceding aspect of the invention; inserting the assembly of primary and secondary pipes into the bore of the pipe scraper such that the first scraper tool rests against the outer surface of the primary pipe and such that the second scraper tool rests against the outer surface of the secondary pipe; and providing torque to the pipe scraper housing along its central axis via the transmission means, thus causing the first and second scraper tools to move with respect to the primary and secondary pipes, causing the primary and secondary pipes to be scraped by the first and second scraper tools.

Preferably wherein torque is delivered to the transmission means of the pipe scraper using a power tool.

Conveniently wherein the pipe scraper further comprises a drive cone and an externally threaded rod, wherein the externally threaded rod is coaxial with and positioned within the bore, and is secured to the housing at the end of the bore that is opposite to the open end, wherein the drive cone comprises a conical frustum that is coaxial with and positioned within the bore, the conical frustum itself having a bore which is internally threaded, and which is at least accessible from the broadest end of the conical frustum, and wherein the internal threads of the drive cone are engaged with the external threads of the externally threaded rod such that the narrowest end of the frustum is nearer the open end of the bore than the broadest end, and wherein the primary pipe is stationary with respect to the frustum while torque is applied, and wherein rotation of the pipe scraper housing with respect to the primary pipe and frustum causes the frustum and primary pipe to advance along the externally threaded rod towards the open end of the bore.

Advantageously wherein the frustum is positioned as far from the open end of the Preferably wherein the primary pipe is stationary with respect to the secondary pipe.

### BRIEF DESCRIPTION OF THE FIGURES

FIG. 1 is a perspective view of a pipe scraper in accordance with the invention.

FIG. 2 is an end view of the pipe scraper of FIG. 1.

FIG. 3 is a cross sectional view of the pipe scraper of FIG. 1, taken in the plane defined by line A of FIG. 2.

FIG. 4 is a cross sectional view of the pipe scraper of FIG. 1, taken in the plane defined by line C of FIG. 2.

FIG. 5 is a schematic view of an assembly of a primary and secondary pipe.

FIG. 6 is a cross sectional view of the pipe assembly of FIG. 5 inserted into the pipe scraper of FIG. 1.

### DETAILED DESCRIPTION OF THE INVENTION

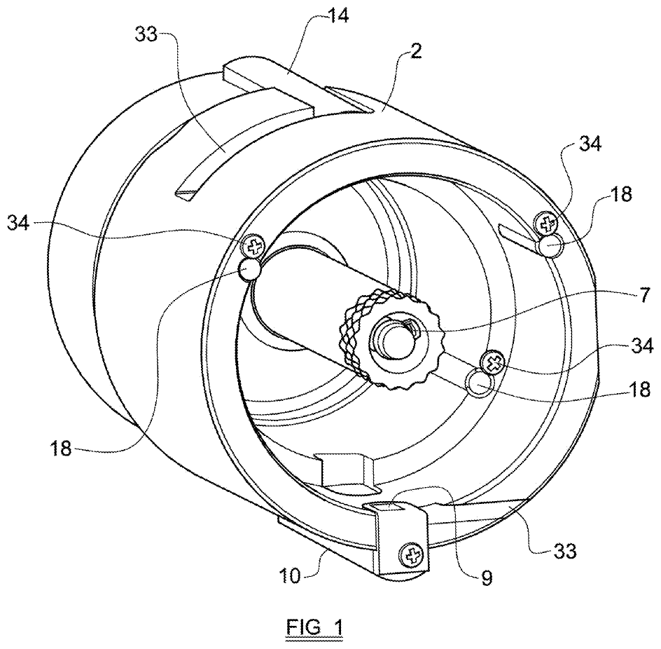

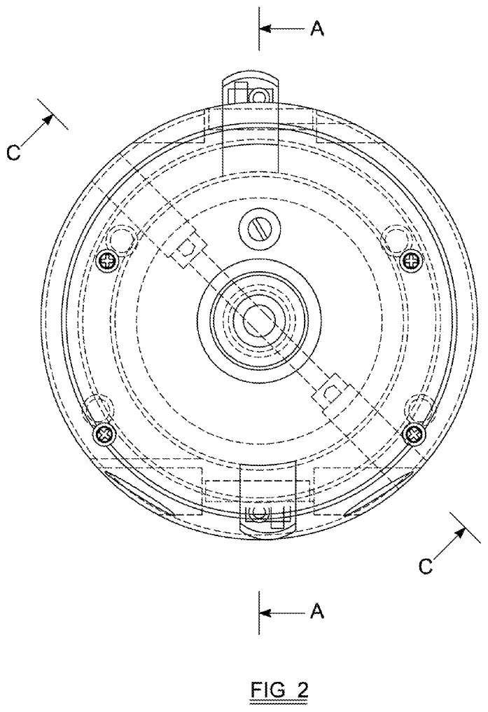

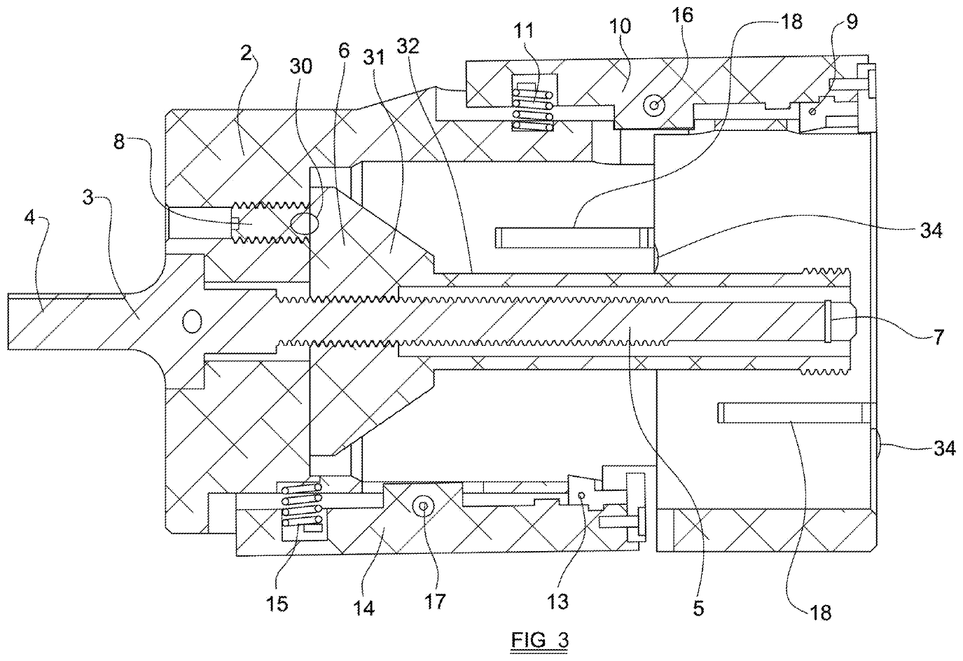

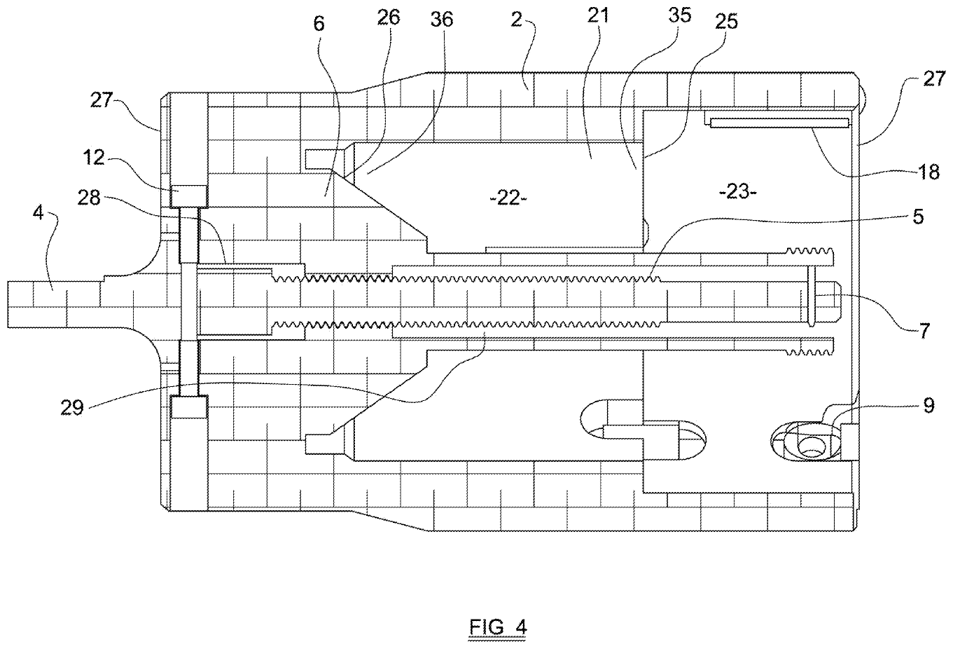

Referring to FIGS. 1 to 4, a pipe scraper 1 in accordance with the invention comprises a housing 2, which has an approximately cylindrical shape with a closed end 27 and an open end 24, and has a bore 21 passing through a portion of the housing 2 which is accessible through the open end 24 of the housing 2. In alternative embodiments the overall shape of the housing may be any shape which allows the housing to stably rotate about the centre axis of the bore, such as a hexagonal prism.

The bore 21 has an open end 24 at the open end of the housing 2, and a closed end 26 at the opposite end of the bore 21. The bore comprises two substantially cylindrical sections 22, 23 which are coaxial with the housing 2. The first section 23 figures, a first end of the first section 23 is adjacent to the open end 24 of the housing 2, and a second end 25 of the first section 23 is located between the open 24 and closed 26 ends of the bore 21. A first end 35 of the second section 22 is preferably adjacent to or aligned with the second end 25 of the first section 23 and a second end 36 of the second section 22 is preferably at the closed end 26 of the bore 21.

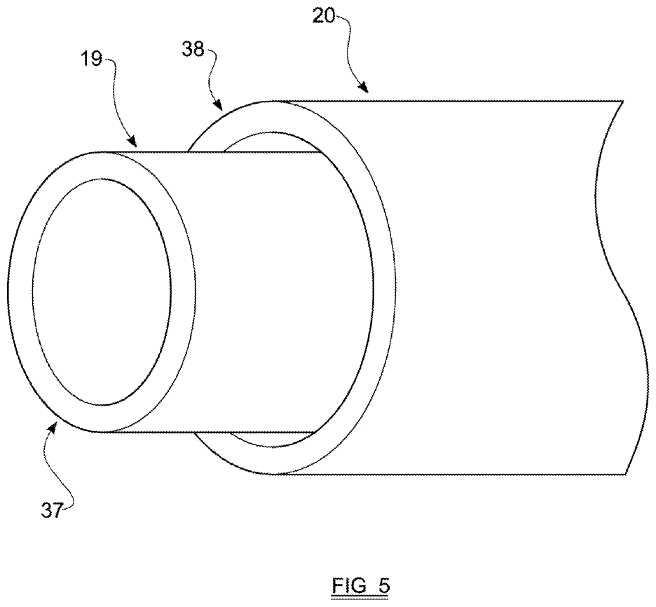

The first cylindrical section 23 has a first diameter and the second cylindrical 22 section has a second diameter which is less than the first diameter. FIG. 5 shows the end of an assembly of a primary pipe 19 and secondary pipe 20 schematically, in a configuration suitable for electrofusion welding of both pipes 19, 20. In this configuration the free end 37 of the primary pipe 19 that is to be welded is separated from the free end 38 of the secondary pipe 20 to be welded by a distance along the axial direction of the assembly such that the primary pipe 19 protrudes from the assembly and exposes a portion of its surface for welding. The shape of the bore 21 of the housing 2 allows such an assembly of concentric primary 19 and secondary pipes 20 to be placed in the bore 21. The external diameter of the primary 19 must be smaller than the internal diameter of the secondary 20. It is contemplated that the primary may have an external diameter of 32, 50, 63, 90, 110 mm, or another suitable diameter. It is contemplated that the secondary may have an external diameter of 40, 63, 75, 110, 125 mm, or another suitable diameter. In preferred embodiments the primary and secondary may respectively have external diameters of 32 and 40 mm, 50 and 63 mm, 63 and 75 mm, 90 and 110 mm, or 110 and 125 mm. The internal diameter of the first section 23 may be chosen to be slightly larger than the external diameter of the secondary pipe 20, and the internal diameter of the second section 22 may be chosen to be slightly larger than the external diameter of the primary pipe 19.

It is contemplated that minor alterations could be made to the above described bore 21, such as chamfering edges within the bore, while remaining within the scope of the invention. It is also contemplated that the shape of the bore could depart significantly from the above described shape while remaining within the scope of the invention.

The housing 2 could be formed from stainless steel or other suitable materials and could be manufactured using a mill, lathe, or a combination of these tools. The skilled reader will appreciate that alternative materials and manufacturing methods could be used without departing from the scope of the invention.

A drive spindle 3 passes through an aperture 28 formed in the closed end 27 of the housing 2 and into the bore 21 through the closed end 26 of the bore 21. The drive spindle 3 is preferably secured to the housing 2, for instance using retaining screws 12 which pass through a portion of the diameter of both the housing 2 and drive spindle 3. This ensures that the drive spindle 3 and housing 2 co-rotate. All or part of the drive spindle 3 could alternatively be formed integrally with the closed end 27 of the housing 2. The drive spindle 3 includes a transmission means 4 exposed at the closed end 27 of the housing 2.

The transmission means 4 is an element which may mate with a fitting for a tool which supplies torque, such as an electric drill or screwdriver. The transmission means 4 may transfer torque to the housing 2 through the drive spindle 3. The transmission means may protrude from the housing 2 (as shown in FIGS. 1 to 4), or may alternatively comprise a groove or indented feature.

A portion of the drive spindle 3 extends into the bore 21 of the housing 2. This portion includes an externally threaded rod 5.

In the example shown a drive cone 6 is positioned within the bore 21. The drive cone 6 has a conical frustum portion 31 and, in the example shown, a cylindrical portion 32 attached to the narrow end of the frustum portion. The broad end of the frustum 31 is nearest the closed end 26 of the bore 21, and the narrow end of the frustum 31 is nearest the open end 24 of the bore 21. The diameter of the cylindrical portion 32 is the same as or smaller than that of the narrow end of the frustum portion 31. A drive cone bore 29 passes though the frustum portion 31, a portion of which is internally threaded such that the threads may engage the threads of the externally threaded rod 5. The drive cone bore 29 also passes through the cylindrical portion 32 such that the drive cone 6 may move in the radial direction along the externally

In preferred embodiments the portion of the drive spindle 3 which extends into the bore 21 of the housing 2 also comprises a removable circlip 7, which prevents advancement of the drive cone 6 to a point at which the internal threads of the drive cone 6 disengage from the external threads of the externally threaded rod 5. It is contemplated that alternative restraining devices may be used to prevent the drive cone 6 advancing along the threaded rod 5 to the point that the drive cone 6 disengages from the threaded rod 5, such as an obstruction permanently secured to the threaded rod 5.

The end of the cylindrical portion 32 of the drive cone 6 nearest the open end 24 of the bore 21 is preferably knurled to texture the end of the cylindrical portion 32, allowing for the cylindrical portion 32 to be more easily gripped by hand.

It is contemplated that the drive cone 6 and drive spindle 3 could be formed from stainless steel or other suitable materials and could be manufactured using a mill, lathe, or a combination of these tools. The skilled reader will appreciate that alternative materials and manufacturing methods could be used without departing from the scope of the invention.

The housing 2 includes an anti-binding ball catch 8, which is secured to the housing 2 in a threaded cavity which passes through the closed end 27 of the housing 2 to the closed end 26 of the bore. The anti-binding ball catch 8 may include a spring or other resilient member that urges an end of the catch 8 towards the open end 24 of the housing 2. In its resting position, the end of the ball catch 8 may extend beyond the cavity into the bore 21 of the housing 2. The threaded cavity and anti-binding ball catch 8 may be positioned such that the drive cone 6 will contact the ball catch 8 before contacting the closed end 26 of the bore 21 when advancing towards the closed end 26 of the bore 21, so that the spring resists the advancement of the drive cone 6 towards the closed end of the bore 26. The anti-binding ball catch 8 may provide tactile feedback to the operator of the pipe scraper 1 once the drive cone 6 is in contact with the catch 8, as the operator may notice increased resistance to advancement of the drive cone 6 along the thread 5, allowing the operator to stop of the bore 21. The urging of the anti-binding ball catch 8 alone may also be sufficient to stop advancement of the drive cone 6 towards the closed end 26 of the bore 21. It may be undesirable for the drive cone 6 to reach the closed end 26 of the bore 21, as it may be locked in place by frictional forces between itself and the bore 21.

Secured to the housing 2 are first and second scraper tool assemblies, comprising first and second scraper tools 9, 13, first and second levers, 10, 14 and first and second urging members 11, 15. The first and second levers 10, 14 are secured to the housing 2 using first and second pivot pins 16, 17 respectively, which allow the levers 10, 14 to pivot 10, 14 about a pivot 16, 17 tangential to the circumference of the housing 2. Each of the first and second levers 10, 14 comprises a first and second lever arm. The first and second lever arms of each lever are positioned on opposite sides of the pivot pin 16, 17 of that lever. An urging member 11, 15 such as a spring is positioned under the first lever arm of each lever, placing it in contact with the outer surface of the housing and the underside of the first lever arm. This urges the first lever arm of each lever radially outwards, and the second lever arm radially inwards. Attached to the inward facing side of the second lever arm of each lever is the respective scraper tool 9, 13 of the scraper tool assembly. The scraper tool 9, 13 is urged radially inwards by the lever arm.

In the example shown each lever 10, 14 is generally parallel with the central axis, with the scraper tool 9, 13 positioned at or near the end of the lever 10, 14 that is closest to the open end 24 of the housing.

The first and second scraper tool assemblies are secured to the cylindrical housing 2 at spaced apart positions such that they are free to pivot independently. In preferred embodiments the scraper tool assemblies are positioned at radially opposite sides of the housing 2. In other embodiments, the scraper tool assemblies may not be displaced from each other in the azimuthal direction, or are displaced from each other in the azimuthal direction by some angle other than 180 degrees.

In the example, cut outs which pass through the entire depth of the housing 2 wall scraper tool assembly is axially positioned such that the first scraper tool 9 extends through the housing 2 and into the first section 23 of the bore 21, for instance at or near the open end of the bore 21. The second scraper tool assembly is positioned such that the second scraper tool 13 extends through the housing 2 and into the bore 21 in the second section 22 of the bore 21, for instance near the boundary between the first 23 and second 22 sections of the bore 21. The scraper tool assemblies are radially positioned such that the surface of the primary 19 that is to be scraped is within the range of motion of the second scraper tool 13, and such that the surface of the secondary 20 that is to be scraped is within the range of motion of the first scraper tool 9. The ranges of motion of the scraper tools 9, 13 also allow for deviations in the diameter and ovalisations of the primary 19 and secondary 20 pipes that are scraped.

The housing 2 also includes waste material channels 33 adjacent to each scraper tool 9, 13 which allow waste material scraped from the pipes to leave the bore 21. In preferred embodiments these waste material channels 33 are cut outs in the housing 2 which start at their respective scraper tool 9, 13, and extend in the direction that waste material is ejected from the tool (i.e. away from the cutting blade) along a tangent to a circle centred on the centre axis of the bore 21 and passing through the scraper tool 9, 13.

The housing 2 also comprises a number of guide rollers 18. In the example shown these guide rollers 18 are paired, and a pair is positioned within each of the first 23 and second sections 22 of the bore 21 in order to guide a secondary 20 and primary 19 pipe respectively. These guide rollers 18 preferably are cylindrical, but in alternative embodiments may be any shape that may freely rotate within an appropriately shaped cavity, such as an hourglass shape. The guide rollers 18 are positioned within cavities in the housing 2, which intersect the bore 21 such that portions of guide rollers 18 are exposed in the bore 21, and are radially prominent with respect to the surface of the bore 21. These guide rollers 18 are retained in the cavities, for instance, using retaining screws 34. In the example shown, a first pair of guide rollers 18 is positioned at approximately the same axial position as the first scraper tool 9, and each guide roller 18 of this pair is separated from this scraper tool the azimuthal direction. In the example shown, a second pair of guide rollers 18 is positioned at approximately the same axial position as the second scraper tool 13, and each guide roller 18 of this pair is separated from this scraper tool 13 and the other guide roller 18 of the pair by an approximately 120 degree angle in the azimuthal direction.

The pipe scraper 1 can be operated by first ensuring that the drive cone 6 is positioned at the closed end of the bore 21. The position of the drive cone 6 can be adjusted by holding the end of the cylinder 32 of the drive cone 6, and rotating the housing 2 or drive spindle 3 with respect to the drive cone 6. This could be done manually or using a power tool such as an electric screwdriver or drill fitted with an appropriate attachment that can be mated with the transmission means 4.

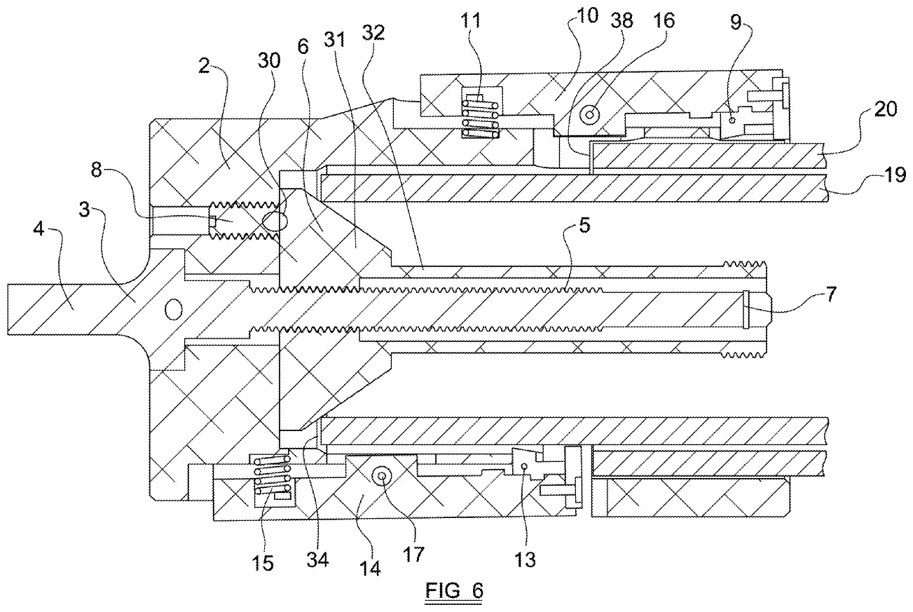

An assembly of a primary 19 and secondary 20 pipe can then be placed in the bore 21 of the housing 2. FIG. 6 shows the pipe scraper with the pipe assembly of FIG. 5 placed within the housing. The end of the primary 19 then rests against the frustum 31 of the drive cone 6. The first scraper tool 9 rests against the exterior surface of the secondary 20, which also rests against a pair of guide rollers 18. The second scraper tool 13 rests against the exterior surface of the primary 19, which also rests against a different pair of guide rollers 18.

Torque is then applied to the pipe scraper 1 through the drive spindle 3, causing the housing 2 to rotate and causing the scraper tools 9, 13 to move with respect to the pipes 19, 20 that they rest against, causing the pipes 19, 20 to be scraped. The scraper tools may be bladed. As the housing 2 rotates, any ovalisations of either pipe 19, 20 are corrected for through movement of the scraper tools 9, 13 radially. The drive cone 6 is held stationary with respect to the pipe assembly by frictional forces between the primary pipe 19 and the surface of the drive cone 6 and the drive cone rotates with respect to the housing 2 and drive spindle 3, causing the drive cone 6 to advance along the threaded rod 5 towards the open end of the bore 21, causing the pipe assembly to advance axially with it. This causes the scraper tools 9, 13 to scrape a length of each pipe 19, 20.

The scraper tools 9, 13 will trace a helical path along the outside of the pipes 19, 20 due to the advancement of the pipe 19, 20 within the pipe scraper 1 during each rotation. The pitch of this helical path is determined by the pitch of the threads of the externally threaded rod 5 and drive cone 6.

If the portions of the pipes 19, 20 that are scraped by a scraper tool 9, 13 at any one time are sufficiently wide, the newly traced helical paths will meet or overlap with the paths traced in the previous rotation, resulting in the entirety of cylindrical portions of the end of each of the primary and secondary pipes being scraped.

In preferred embodiments the scraper tool 9, 13 and the pitch of the threads are chosen to ensure that the entirety of the end portion of each of the primary 19 and secondary 20 pipes is scraped, leaving no unscraped pipe surfaces between portions of the helical paths traced by the scraper tools.

The drive cone 6 and pipe assembly will advance until torque is no longer applied, or the advancement of the drive cone 6 is halted by the circlip 7. This prevents accidental removal of the drive cone 6 from the threaded rod 5, and also discourages intentional removal of the drive cone 6 by an operator. If the drive cone 6 is removed, the operator of the pipe scraper 1 will need to control the rate at which the pipe scraper 1 advances manually. This could result in uneven or inadequate scraping across the scraped surfaces of the pipes 19, 20.

The above described pipe scraper 1 has several advantages over the prior art scraper of EP 2 368 656 B1.

The additional length of a pipe assembly due to a primary pipe 19 prevents the insertion of the entire portion of a secondary pipe 20 that is to be scraped into a pipe scraper according to EP 2 369 656 B1 which is otherwise suitable for use with the secondary pipe 20.

Additionally, the presence of the secondary pipe 20 may prevent the insertion of the entire portion of a primary pipe 19 that is to be scraped into a pipe scraper according the primary pipe 19 extends significantly further from the end of the assembly than the secondary 20 will the prior art pipe scraper be suitable for use with the primary 19.

The above described pipe scraper 1 may accommodate the end of such an assembly of primary 19 and secondary 20 pipes. The pipe scraper 1 may also scrape both at the same time using one pipe scraper 1 device. This may reduce the cost of purchasing tools for installing and maintaining system of primary 19 and secondary 20 pipes, reduce the burden of transporting and storing such tools, and decrease the time taken to install a system of primary 19 and secondary 20 pipes.

Additionally, the inclusion of a circlip 7 to retain the drive cone 6 encourages the operator of the device to scrape the pipes at a rate that ensures the entirety of the area to be scraped is scraped. In contrast, the drive cone 6 of the prior art must be removable to allow the prior art scraper to face pipes (i.e. ensure that the end of the pipe lies in a plane perpendicular to the centre axis of the pipe).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1-13. (canceled)

14. A pipe scraper comprising:
a housing comprising a bore having a center axis and an open end that allows access to the bore, the bore being shaped to receive into its open end at least a portion of each of two pipes of an assembly of two concentric pipes, wherein the assembly of two concentric pipes comprises a pipe having a smaller diameter, and a pipe having a larger diameter, and the end of the pipe having the larger diameter is separated from the end of the pipe having the smaller diameter by a distance along the central axis of the assembly;
a first scraper tool assembly secured to the housing, configured to urge a first scraper tool radially inwards, and positioned at a first radial distance from the center axis of the bore, and at a first axial distance from the open end of the bore;
a second scraper tool assembly secured to the housing, configured to urge a second scraper tool radially inwards, and positioned at a second radial distance from the center axis of the bore, and at a second axial distance from the open end of the bore, wherein the first radial distance is smaller than the second radial distance, and the first axial distance is larger than the second axial distance; and
a transmission to allow torque to be delivered to the housing to cause rotation of the housing about the center axis of the bore;
wherein the first scraper tool is configured so that rotation of the housing will cause the first scraper tool to scrape portions of a pipe that are in contact with the first scraper tool, and wherein the second scraper tool is configured so that rotation of the housing will cause the second scraper tool to scrape portions of a pipe that are in contact with the second scraper tool.

15. A pipe scraper according to claim 14, further comprising a drive cone and an externally threaded rod,
wherein the externally threaded rod is coaxial with and positioned within the bore, and is secured to the housing at the end of the bore that is opposite to the open end,
wherein the drive cone comprises a conical frustum that is coaxial with and positioned within the bore, the conical frustum itself having a bore that is internally threaded, and that is at least accessible from the broadest end of the conical frustum,
and wherein the internal threads of the drive cone are engaged with the external threads of the externally threaded rod such that the narrowest end of the frustum is nearer the open end of the bore than the broadest end.

16. A pipe scraper according to claim 15, wherein the drive cone further comprises a cylindrical element integrally formed with or secured to the narrowest end of the frustum, wherein the cylindrical element also comprises a bore that is continuous with the bore of the frustum, and that may receive the externally threaded rod.

17. A pipe scraper according to claim 15, wherein the externally threaded rod further comprises a restraining element that may prevent the advancement of the drive cone towards the open end of the bore to a position in which the drive cone would disengage from the internally threaded rod.

18. A pipe scraper according to claim 15, wherein the end of the housing opposite the open end further comprises an anti-binding ball catch having a catch urging member configured to urge an end of the catch into the bore and away from the end of the housing opposite the open end, the anti-binding ball catch being positioned such that one end of the catch extends into the bore when the catch urging member is in a resting position.

19. A pipe scraper according to claim 14, wherein one of the first and second scraper tool assemblies comprises a lever, an urging member, and the scraper tool, wherein the lever is secured to the housing such that the arms of the lever may pivot radially inwards and outwards with respect to the housing, wherein the scraper tool is attached to a first arm of the lever, and wherein the urging member is arranged to urge the second arm of the lever is radially outwards.

20. A pipe scraper according to claim 14, wherein the housing further comprises guide rollers, the guide rollers being components that may freely rotate within cavities in the housing, wherein these cavities are adjacent to and intersect with the bore such that the guide rollers are secured within the cavities and portions of the guide rollers protrude into the bore along the length of the rollers.

21. A pipe scraper according to claim 14, wherein the bore of the housing comprises a first section having a first internal diameter, and a second section having a second internal diameter, and wherein the first section is located axially closer to the free end of the bore than the second section, and wherein the first internal diameter is larger than the second internal diameter, and wherein the first scraper tool is located in the first section, and the second scraper tool is located in the second section.

22. A method of scraping one end of an assembly of a primary pipe and a secondary pipe, wherein the primary pipe is concentric or substantially concentric with the secondary pipe, and the primary pipe has a smaller radius than that of the secondary pipe, wherein the end of the primary pipe lies in a first plane perpendicular to the central axis of the assembly, and the end of the secondary pipe lies in a second plane perpendicular to the central axis of the assembly wherein the first and second planes are separated by a distance and wherein the primary pipe intersects the second plane, and the secondary pipe does not intersect the first plane, such that at least a portion of the primary pipe can be accessed by a tool moving radially inwards from the outside of the primary and secondary pipes, including:
providing a pipe scraper in accordance with claim 14;
inserting the assembly of primary and secondary pipes into the bore of the pipe scraper such that the first scraper tool rests against the outer surface of the primary pipe and such that the second scraper tool rests against the outer surface of the secondary pipe; and
providing torque to the pipe scraper housing along its central axis via the transmission, causing the first and second scraper tools to move with respect to the primary and secondary pipes, thus causing the primary and secondary pipes to be scraped by the first and second scraper tools.

23. The method of claim 22 wherein torque is delivered to the transmission of the pipe scraper using a power tool.

24. The method of claim 22 wherein the pipe scraper further comprises a drive cone and an externally threaded rod, wherein the externally threaded rod is coaxial with and positioned within the bore, and is secured to the housing at the end of the bore that is opposite to the open end, wherein the drive cone comprises a conical frustum that is coaxial with and positioned within the bore, the conical frustum itself having a bore that is internally threaded, and that is at least accessible from the broadest end of the conical frustum, and wherein the internal threads of the drive cone are engaged with the external threads of the externally threaded rod such that the narrowest end of the frustum is nearer the open end of the bore than the broadest end, and wherein the primary pipe is stationary with respect to the frustum while torque is applied, and wherein rotation of the pipe scraper housing with respect to the primary pipe and frustum causes the frustum and primary pipe to advance along the externally threaded rod towards the open end of the bore.

25. The method of claim 24 wherein the frustum is positioned as far from the open end of the bore as is allowed by the pipe scraper before torque is delivered to the housing.

26. The method of claim 24 wherein the primary pipe is stationary with respect to the secondary pipe.
